(19) United States
(12) Patent Application Publication
(10) Pub. No.: US 2007/0076099 A1
(43) Pub. Date: Apr. 5, 2007

(54) Device and method for hybrid resolution video frames

(76) Inventors: Eyal Eshed, Mazor (IL); Ben Kidron, Sde-Varborg (IL); Edwin Thompson, Campbell Hall, NY (US)

Correspondence Address: PEARL COHEN ZEDEK LATZER, LLP, 1500 BROADWAY 12TH FLOOR, NEW YORK, NY, 10036, US

(21) Appl. No.: 11/414,370

(22) Filed: May 1, 2006

Related U.S. Application Data
(60) Provisional application No. 60/722,429, filed on Oct. 3, 2005.

(51) Int. Cl. H04N 5/225

(52) U.S. Cl. 348/218.1; 348/239

(57) ABSTRACT

A system and method of displaying a first part of a view captured by two or more image sensors in one or more first pixel resolutions, and a second part of a view captured by such image sensors in a second one or more pixel resolutions.

### CROSS REFERENCE TO RELATED APPLICATIONS

This application claims the benefit of U.S. Provisional Patent Application No. 60/722,429 filed on Oct. 3, 2005, and entitled Apparatus and Method for Hybrid Resolution Video Frames, incorporated by reference herein in its entirety.

### FIELD OF THE INVENTION

The present invention relates generally to the capture of images, and particularly to the processing and viewing of streams of images that includes different pixel resolutions densities at different areas of interest of a view.

### BACKGROUND OF THE INVENTION

Combining or stitching multiple video streams to create a wide view of an area of interest is used in fields such as for example security surveillance or industrial control. Pan, tilt zoom (PTZ) cameras that may zoom in on a particular area of interest of a view are also used. When using a PTZ camera, a user may lose some or part of the wide view as the camera focuses on a small area of the view. Furthermore, a first segment of a wide view may be captured at a first resolution, and a second segment of a wide view may be captured at a second resolution.

### SUMMARY OF THE INVENTION

In some embodiments, the invention includes a system having more than one image sensor; and a processor to reference a group of pixels captured by a first of the image sensors at a first resolution to a segment of a model of a view, and to reference a group of pixels captured by a second of image sensors at a second resolution to the segment of the model of the view, and to display a first part of the segment of the view in a first scale, where such display of the first part of the segment has a first set of resolutions, and to display a second part of the segment of the view in a second scale, where the display of the second part of the segment has a second set of resolutions.

In some embodiments, the processor is to accept an instruction from an input device to alter a stitch of the view captured by the first image sensor and of the view captured by the second image sensor.

In some embodiments a physical position of the first image sensor may not be calibrated to a position of the second image sensor.

In some embodiments, the processor may alter a second scale in response to a signal from an input device.

In some embodiments, an image sensor may be or include any or all of a digital video camera, a digital still camera, an analog video camera, an analog still camera, an infra red sensor, a radar sensor or an Xray sensor. In some embodiments, an image sensor may be or include a: pan-tilt-zoom camera. In some embodiments, a segment of an image may include less than all of the view in such image. In some embodiments the processor may define a size or area of a segment in response to a signal from an input device.

Some embodiments of the invention may include a method of referencing to a segment of a model of a view, a group of pixels captured by a first of a group of image sensors at a first resolution, referencing to the segment of the model of the view, a group of pixels captured by a second of the group of image sensors at a second resolution, displaying a first part of the segment of the view in a first scale, such display of the first part of the segment having a first set of resolutions and displaying a second part of the segment of the view in a second scale, having a second set of resolutions.

### BRIEF DESCRIPTION OF THE DRAWINGS

Embodiments of the invention are illustrated by way of example and not limitation in the figures of the accompanying drawings, in which like reference numerals may indicate corresponding, analogous or similar elements, and in which:

FIG. 1 is a conceptual illustration of a view captured by one or more image sensors having different resolutions, in accordance with an embodiment of the invention; and

FIG. 2 is a block diagram of a method in accordance with some embodiments of the invention.

It will be appreciated that for simplicity and clarity of illustration, elements shown in the figures have not necessarily been drawn to scale. For example, the dimensions of some of the elements may be exaggerated relative to other elements.

### DETAILED DESCRIPTION OF THE INVENTION

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods, procedures, and components have not been described in detail so as not to obscure the embodiments of the invention.

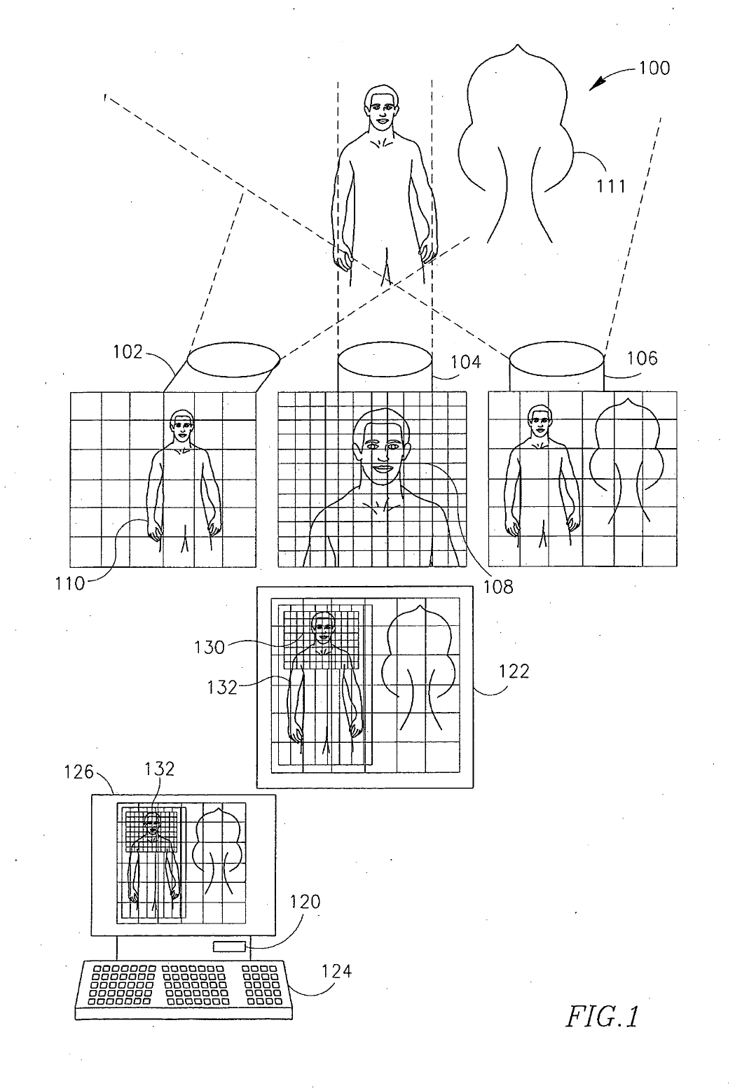

Reference is made to FIG. 1, a conceptual illustration of a view captured by one or more image sensors having different resolutions, in accordance with an embodiment of the invention. In some embodiments, one or more images or streams of images may be captured of one or more objects, or parts of objects or of a group of objects in a view 100 of objects. In some embodiments, images of view 100 may be captured by one or more images sensors 102, 104 and 106. In some embodiments, images sensors 102, 104 and 106 may capture images of for example view 100 at the same or different resolutions. For example, image sensor 106 may be or include a low resolution video camera, that may capture images at a resolution of 1 million pixels per frame, image sensor 102 may be or include a medium resolution camera, that may capture images at a resolution of 4 million pixels per frame, and image sensor 104 may be or include a high resolution video camera, that may capture images at a resolution of 10 million pixels per frame. Other numbers of cameras having other resolutions may be used. In some embodiments, a lens on an image sensor 102 may influence or determine a resolution of an image captured with such image sensor 102.

In some embodiments, one or more of image sensors 102, 104 or 106 may be or include for example a digital video camera, a digital still camera, an analog video camera, an analog still camera, an infra red sensor, a radar sensor, an X-ray sensor or other device to capture an image or stream of images. In some embodiments, an image sensor 102 may be or include for example a PTZ camera that may zoom a lens upon for example an instruction from a user.

In some embodiments image sensor 104 may be focused on for example a particular object in view 100, such as for example upon a face 108 of a person in view 100. Other objects or sizes of objects may be the subject of a focus of image sensor 104. Image sensor 102 may be focused on for example a body 110 of a person, and the images captured by image sensor 102 may include some, all or none of face 108. Image sensor 106 may be focused on a wider area of view 100 and such wider area may include all, some or none of body 110.

In some embodiments, a processor 120, such as for example a central processor unit that may be found in a personal computer, video console, or other electronic device, may generate a virtual map, matrix, model 122 or other set of multi-dimensional coordinates that may represent some or all of the area between some or all of the objects in view 100 and some or all of the image sensors 102, 104 and 106. For example, in some embodiments, model 122 may map view 100, as it may be captured by for example image sensor 106. In some embodiments, a processor such as for example processor 120 may reference the pixels captured by one or more of image sensors 102, 104 and 106 onto the model 122. For example, coordinates x and y of model 122 may indicate the location of a pixel or group of pixels representing face 108 in the image captured by image sensor 106 or in some other section or segment of view 100. Processor 122 may then associate or reference the pixel or group of pixels that include face 108 as was captured by image sensor 102 over the same coordinates of model 122 that include face 108, and may similarly map, reference or associate the pixels or group of pixels that include face 108 as were captured by image sensor 104 on those same coordinates. In some embodiments, the higher density pixels, such as those captured by image sensor 104 may write over pixels from lower resolution images that may have been mapped to the same coordinates of model 122.

In some embodiments, the segments of view 100 that are captured by the various images sensors 102, 104 and 106 may not overlap, such that for example, only image sensor 1.04 capture an image of face 108, and only image sensor 102 may capture an image of body 110, and only image sensor 106 may capture an image of tree 111. In such case, processor 120 may map or create a model 122 of the various parts of the view 100 that are captured by the respective image sensors 102, 104 and 106, and may stitch the images together in model 122.

In some embodiments, a physical position, angle or location of one image sensor 102, may be moved or altered relative to a position of another image sensor 104, and processor 120 may not be required to calibrate such positions or angles. A calibration may be accomplished at for example model 122 where the pixels from the image sensors 102, 104 106 may be overlaid onto model 122.

In some embodiments, the mapping or referencing of pixels captured by different image sensors 102, 104, 106 may be performed by for example stitching of the images captured or by other means.

In some embodiments, the map or model 122 of view 100 may include pixels having different resolutions or pixel densities. For example, pixels 130 mapped onto model 122 from image sensor 104 may have a density of 10 million pixel per frame, while pixels 132 mapped onto model 122 from image sensor 106 may have a density of 1 million pixel per frame.

In some embodiments, processor 120 may display an image that may include for example a wide or panoramic range of view 100. The displayed image may include pixels from the various streams of image sensors 102, 104 106 that may have been stitched together by processor 120. Such stitching may in some embodiments be adjusted by a user by way of signals from input device 124. In some embodiments, the displayed image of view 100 may include parts or segments having pixels captured by some or all three image devices 102, 104 and 106, and having several resolutions. In such an image, a scale of the objects in view 100 may be preserved to offer a consistent size of objects in the image, even though the pixel resolutions of such objects may differ. In some embodiments, a screen 126 or other display medium may not have sufficient pixels capacity to show the resolution of for example the area 134 in the image that was captured in high resolution. To accommodate the lack of resolution available to display 126, processor 120 may delete or not show some of the pixels that may be available from model 122.

In some embodiments, a signal or instruction from for example a user or other operator may designate one or more areas of an image for display at a high resolution, and other areas of an image for display at a lower resolution. In some embodiments, processor 120 may alter or adjust a scale of the objects displayed in for example a high resolution area. Such adjustment of scale may provide more room on display 26 to see the objects slated for high definition display so that more pixels on the display 26 can be included in the image of the object. In some embodiments, an area designated for, for example, high definition viewing may include pixels at several resolution rates.

For example, a user or other operator may instruct a processor to display face 108 and an upper part of body 110 at a high resolution or pixel density rate. The segment of the displayed image of face 108 and part of body 110 may include at least two pixel resolution rates and a scale of face and upper part of body 110 may be increased to allow the higher resolution to be seen on a larger part of display 126. At, for example, a same or different time, a lower part of body 110 and tree 111 may be displayed at one or more lower resolution or pixel density rates at a scale similar to that of for example other parts of the displayed image.

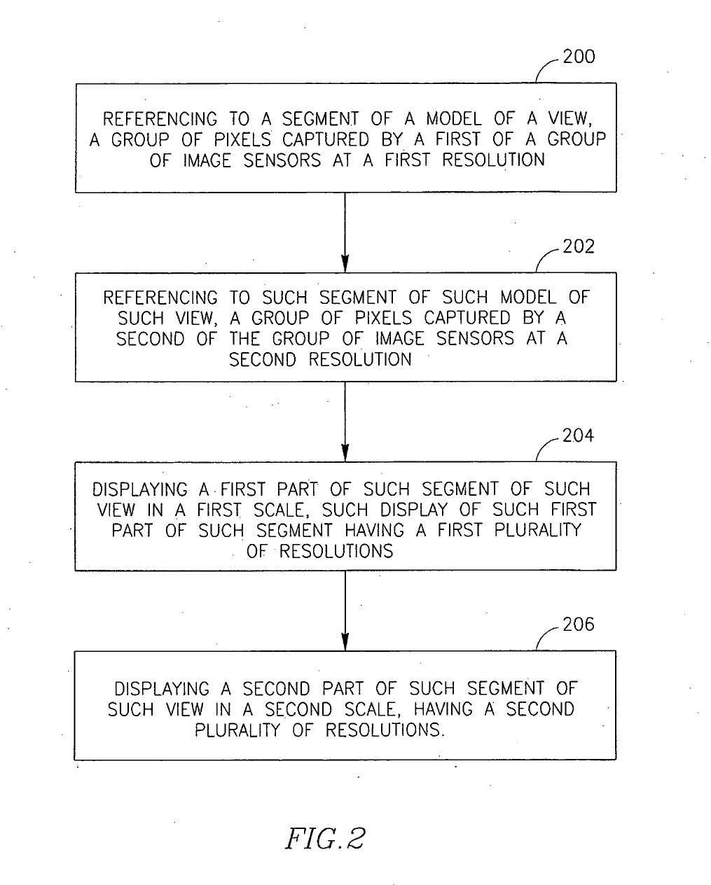

Reference is made to FIG. 2, a flow diagram of a method in accordance with an embodiment of the invention. In block 200, a processor may reference or map a group of pixels captured by a first of a group of image sensors to a segment of a model of a view at a first resolution. In block 202, the same or another processor may reference or map a group of pixels captured by a second of the group of image sensors to such segment of such model of such view, at a second resolution. In block 204, the same or another processor may display a first part of such segment of such view in a first scale, such display of such first part of such segment having a first set of pixel resolutions. In block 206, the same or another processor may display a second part of such segment of such view in a second scale, having a second set of resolutions.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the spirit of the invention.

We claim:

1. A system comprising:
a plurality of image sensors; and
a processor to
reference to a segment of a model of a view, a plurality of pixels captured by a first of said plurality of image sensors at a first resolution;
reference to said segment of said model of said view, a plurality of pixels captured by a second of said image sensors at a second resolution, wherein said second resolution is a different resolution that said first resolution;
display a first part of said segment of said view in a first scale, said display of said first part of said segment having a first plurality of resolutions; and
display a second part of said segment of said view in a second scale, having a second plurality of resolutions.

2. The system as in claim 1, where said processor is to accept an instruction from an input device to alter a stitch of said view captured by said first image sensor and of said view captured by said second image sensor.

3. The system as in claim 1, wherein a physical position of said first image sensor is not calibrated to a position of said second image sensor.

4. The system as in claim 1, wherein said processor is to alter said second scale in response to a signal from an input device.

5. The system as in claim 1, wherein said image sensor is selected from the group consisting of a digital video camera, a digital still camera, an analog video camera, an analog still camera, an infra red sensor, a radar sensor and an X-ray sensor.

6. The system as in claim 1, wherein said image sensor is a pan-tilt-zoom camera.

7. The system as in claim 1, wherein said segment comprises less than all of said view.

8. The processor as in claim 1, wherein said processor is to define said first part in response to a signal from an input device.

9. A method comprising:
referencing to a segment of a model of a view, a plurality of pixels captured by a first of a plurality of image sensors at a first resolution;
referencing to said segment of said model of said view, a plurality of pixels captured by a second of said image sensors at a second resolution;
displaying a first part of said segment of said view in a first scale, said display of said first part of said segment having a first plurality of resolutions; and
displaying a second part of said segment of said view in a second scale, having a second plurality of resolutions.

10. The method as in claim 9, comprising accepting an instruction from an input device to alter a stitch of said view captured by said first image sensor and of said view captured by said second image sensor.

11. The method as in claim 9, comprising calibrating an image from said first image sensor and said second image sensor on said model.

12. The method as in claim 9, comprising altering said second scale in response to a signal from an input device.

13. The method as in claim 9, comprising zooming an optical lens of said first image sensor.

14. The method as in claim 9, comprising displaying less than all of an image captured by said image sensors.

15. The method as in claim 9, defining a boundary of said first part in response to a signal from an input device.

16. A storage device including a medium have stored thereon a series of instructions that when executed result in:
referencing to a segment of a model of a view, a plurality of pixels captured by a first of a plurality of image sensors at a first resolution;
referencing to said segment of said model of said view, a plurality of pixels captured by a second of said image sensors at a second resolution;
displaying a first part of said segment of said view in a first scale, said display of said first part of said segment having a first plurality of resolutions; and
displaying a second part of said segment of said view in a second scale, having a second plurality of resolutions.

17. The device as in claim 16, having instructions that when executed further result in accepting an instruction from an input device to alter a stitch of said view captured by said first image sensor and of said view captured by said second image sensor.

18. The device as in claim 16, having instructions that when executed further result in calibrating an image from said first image sensor and said second image sensor on said model.

19. The device as in claim 16, having instructions that when executed further result in altering said second scale in response to a-signal from an input device.

20. The device as in claim 16, having instructions that when executed further result in zooming an optical lens said first image sensor.
